(19) United States
(12) Patent Application Publication
(10) Pub. No.: US 2003/0133016 A1
(43) Pub. Date: Jul. 17, 2003

(54) METHOD AND APPARATUS FOR RECORDING INCIDENTS

(76) Inventor: CHUK DAVID CHAN, LAWRENCEVILLE, GA (US)

Correspondence Address: C. David Chan, 11 Westview Avenue, North Salem, NY, 10560, US

(21) Appl. No.: 09/352,661

(22) Filed: Jul. 7, 1999

(51) Int. Cl. H04N 9/47

(52) U.S. Cl. 348/207.99; 348/148; 348/231.99

(57) ABSTRACT

A method and apparatus for capturing the visual scenes of an incident so many seconds before, during and after the incident has occurred is disclosed. The apparatus can provide additional functionality of capturing the activities of the operator of a transportation system as well as the sound wave of the environment before, during and after an incident. The disclosed method and apparatus can be used in a land, sea and air based transportation system as well as a traffic monitoring system. The apparatus uses a digital first-in-first-out bufferring mechanism to allow for capturing of an event that may occur at any time in an infinite time span using a finite stoage. The apparatus is comprised of a control unit for overall operational control, a memory unit for temporally storage, an imaging capturing unit for capturing visual scene, a digital sensor for triggering an automatic preservation of captured scenes, a digital sound recorder for capturing sound wave matching the recorded images, a persistent storage unit for preserving of captured scene and sound wave, a power source to allow for continued operation and a protective housing to resist environmental damages.

### BACKGROUND OF THE INVENTION

1. Field of the Invention

This invention generally relates to the field of navigation and recording apparatus. More particularly, this invention relates to digital imaging and audio apparatus used for recording events before, during and after an incident pertaining to a land, sea or air based transportation system.

2. Background of Invention

Every few minutes around the country and the world, there is an accident involving a land, sea or air based transportation system. In some cases, there are no survivors or eye-witnesses to give an account of what happened. Even with eye-witnesses or survivors, there are often disputes of the different accounts of what actually happened. As a result, millions of dollars are wasted in lengthy investigations and litigation leading to higher insurance premiums for society. Moreover, unable to accurately determine the cause of an accident, lessons are not learned to prevent future reoccurrence of similar tragedies.

For many years, ‘black box’ apparatus using audio and electromechanical recording means have been deployed on aircraft to provide investigators important clues of what may have occurred before a plane crash. Likewise, ‘black box’ apparatus using electromechanical means can be found near the engines of some land vehicles which record the speed and operator performance data that allows investigators to recreate a profile of what has occurred based on such physical data. However, one of the most valuable forms of evidence, a visual recording of the actual scene within the vicinity of the subject, are often unavailable.

In theory, one can use a security camera or a camcorder to capture the visual scene of an entire trip. In practice, these kinds of recording systems are only suitable for law enforcement purposes as in a police car or inside a building. This is because in the case of law enforcement and security applications, every minute of what has occurred can be crucial in an investigation. In such applications, there is no way to automatically determine what is important and to just record the portion of the scenario and to skip the rest. However, in the case of accident or incident recording, the general pattern is that only the last few minutes of the record prior to, during and after the accident contain useful information. While capturing a few pictures after an accident has occurred is insufficient and too late, to record scenes of an entire trip is not cost effective and is wasteful because it requires a lot of storage media.

Prior art provided by U.S. Pat. Nos. 5,596,382 and 5,568,211 as well as U.S. Pat. No. 5,262,813 disclose of mechanical apparatus able to capture, via a mechanical camera, a road scene upon impact activated by mechanical trigger mechanisms during a car accident. However, these systems relied solely on rigid mechanical capturing means with limited storage capabilities and are not very flexible in the manner they operate and thus cannot be used conveniently to provide the maximum benefit. These prior inventions focused primarily on trigger mechanisms using mechanical means for land vehicles upon impact.

U.S. Pat. No. 5,899,956 disclosed a digital navigation system capable of recording accident scene for land vehicles. Despite of the fact that the disclosed invention incorporated a mechanism which satisfies the need to automatically capture and preserve the accident scene moments prior to, during and after the occurrence of an accident, it is designed primarily to be used inside a land-based vehicle. What is needed is an apparatus with a narrowed functionality suitable to be used inside a land, sea and air transportation system. In addition, such an apparatus should be able to be used as an external device for monitoring moving transportation systems and to record an incident when it occurs. Examples of such external usage outside of a moving vehicle include roadway intersections, rail-road crossings, underground subway stations. Such an improvement through simplification and generalization is necessary in order to reduce manufacturing cost by allowing the same apparatus to be used in multiple environments for a wider population of the public in the society.

Furthermore, many documented cases of accidents are caused by operators not being alert or awake while operating the vehicles. Therefore, in addition to having forward-looking capability in an accident recording apparatus, it is beneficially to provide a backward-looking capability to capture the activities of the operator and the side and back view of an accident scene.

As a modern society that values human lives, the need to be able to have available visual presentation for safety engineers in preventing future accidents of similar nature has long been called for. Given the increasing high cost of incident investigation, liability and litigation, the ability to establish cause, and place fault with viable evidence is becoming more urgent. What is desperately needed in the society is an incident recording apparauts that can be manufactured in a cost effective manner capable of capturing and preserving the actual evidence prior to, during and after an incident regardless of whether a passenger is riding in a land, sea or air based transportation system.

### SUMMARY OF THE INVENTION

The present invention is generally directed to satisfying the needs set forth above.

One objective of the invention is to capture the visual scene of an incident so many seconds before, during and after the incident has occurred involving a land vehicle to include a passenger car, bus, van, truck and train.

Another objective of the invention is to capture the visual scene of an incident so many seconds before, during and after the incident has occurred involving a sea-based vehicle to include a speed-boat.

Another objective of the invention is to capture the visual scene of an incident so many seconds before, during and after the incident has occurred involving an air-based transportation system such as a passenger jet.

Another objective of the invention is to capture the activities of the operator of a transportation system so many seconds before, during and after an incident has occurred.

Yet another objective of the invention is to capture the sound wave of an incident so many seconds before, during and after the incident has occurred as a supplement to the visual evidence.

Yet another objective of the invention is to allow the same apparatus to be used as an external monitoring device for recording incidents of moving subjects.

Yet another objective of the invention is to allow the same apparatus to be used as a hand-held device for recording incidents.

Yet another objective of the invention is to reduce the manufacturing cost by allowing the same apparatus to be used in multiple environments for applications having similar patterns.

In accordance with one preferred embodiment of the present invention, the foregoing need can be satisfied by providing a digital incident recording apparatus, comprising: a control unit, 10, for operating the apparatus; a memory unit, 20, for holding computer executable instructions; a persistent memory unit, 30, for providing persistent storage; an imaging capturing unit, 40, for capturing visual scene; a digital sensor, 50, for triggering an automatic preservation of captured scenes, an optional digital audio recorder, 60, for capturing surrounding sound wave to sync up with the recorded images, a power source, 70, to allow for continued operation and, 80, a protective housing.

Other objects and advantages of this invention will become readily apparent as the invention is better understood by reference to the accompanying drawings and the detailed description that follows.

### BRIEF DESCRIPTION OF THE DRAWINGS

FIG. 1 is a schematic block diagram showing the essential components of one embodiment of the present invention.

FIG. 2 is a schematic block diagram showing in more detail the essential components of one embodiment of the present invention.

FIG. 3 is a schematic block diagram showing one preferred embodiment of how to preserve a fixed number of images using a finite storage for an unlimited period of time.

FIG. 4 is a schematic block diagram showing another preferred embodiment of how to preserve a fixed number of images using a finite storage for an unlimited period of time.

### DESCRIPTION OF THE PREFERRED EMBODIMENT

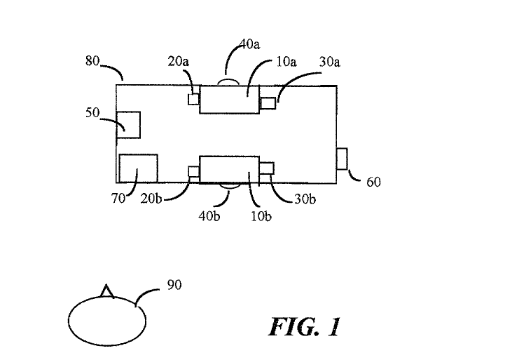

Referring now to the drawings wherein are shown preferred embodiments and wherein like reference numerals designate like elements throughout, there is shown in FIG. 1 a schematic block diagram showing the essential components of one embodiment in accordance with the present invention.

As shown in FIG. 1, the digital system comprises: a control unit, 10, for operating the system; a memory unit, 20, for temporily storage; a forward-looking image capturing unit, 40a, for capturing front view scenes; a backward looking image capturing unit, 40b, for capturing the rear and side view as well as the activities of the operator, 90; a digital sound recorder, 60, for capturing the surrounding sound wave to sync up with the recorded images captured by the imaging unit, 40; a persistent storage, 30, for providing persistent storage of the images captured by the image capturing unit, 40, and sound wave captured by the sound recorder, 60; a power source, 70, to supply the power to allow for continuing operation and a protective housing, 80, to protect the overall construction of the system.

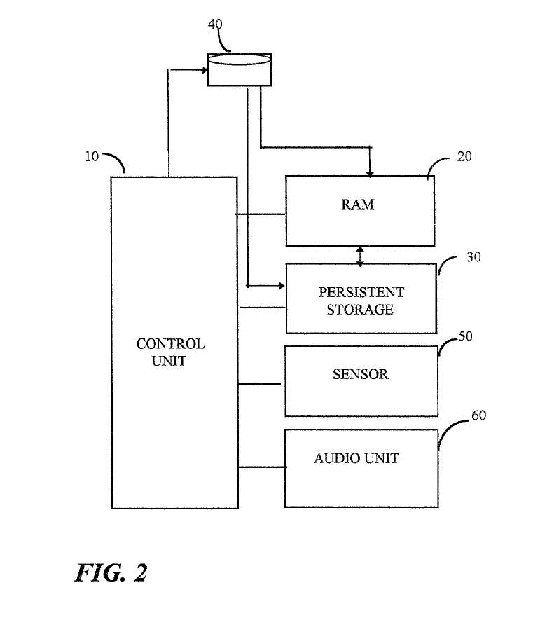

FIG. 2 is a schematic block diagram showing in more detail the essential components of one embodiment of the present invention. It is seen to comprise: an image capturing unit, 40, which can be a CCD or CMOS device; a memory unit 20; a persistent storage 30; a digital sensor, 50, for sensing external events as to trigger the termination of capturing process of images and audio so as to preserve the data in the persistent storage, 30 and a sound recorder, 60 and a control unit, 10, which connects to all major units to provide overall synchronization and operational control.

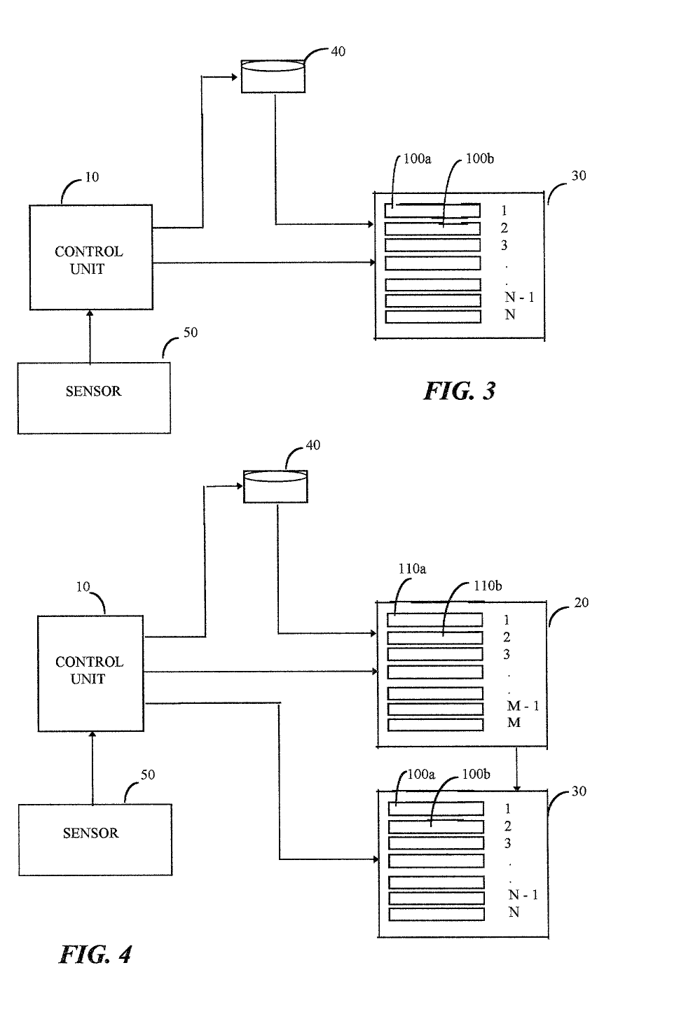

FIG. 3 is a detailed block diagram showing one preferred embodiment wherein images captured by image capturing unit, 40, are fed into a persistent storage, 30, which has a limited storage capacity made up of N numbers of individual storage cells, 100a, 100b and so on. The captured images are to be stored into each cell in a first-in-first-out fashion such that at any given time, a fixed number of images are to be buffered up representing the consecutive frames of actual scene. With such an arrangement, the latest images captured will replace the earliest images when the last storage cell is reached until such time when the control unit, 10, stops any further images to be inserted into a cell so that the buffered images can be persistently preserved. The number of consecutive images to be preserved is a function of the number of storage cell N. This mechanism is designed to overcome the storage problem associated with the fact that an incident can occur at any time within an unlimited time span, therefore it is essential to have an economical way to selectively preserve only valuable data.

FIG. 4 is another preferred embodiment wherein the captured images are to be first inserted into a volatile memory, 20, and from which the data are then pull into the persistent storage, 30, controlled by the control unit, 10.

It is to be noted that in addition to holding captured images, the persistent storage, 30, along with the storage mechanism as shown in FIGS. 3 and 4, can be used to hold digital sound wave captured by the audio unit, 60. Furthermore, the persistent storage, 30, can be used to hold computer executable instructions and thus replaces or eliminates the memory unit, 20, if so chosen. It is worth to point out that persistent storage, 30, may be substituted by other forms of persistent storage media to achieve a similar result even though most of such persistent storage media tend to have a slower performance. Moreover, the persistent storage, 30, can also be achieved or simulated by contineously powering up a volatile memory so as to retain its contains. Likewise, the control unit, 10, can be selected from the group consisting of a microprocessor, a micro-controller, a DSP, a PAL, an EPLD, a FPGA and other forms of programmable logic circuits to provide the necessary control functionality.

Although the foregoing disclosure relates to preferred embodiments of the invention, it is understood that these details have been given for the purposes of clarification only. Various changes and modifications of the invention will be apparent, to one having ordinary skill in the art, without departing from the spirit of the invention as hereinafter set forth in the claims.

What is claimed is:

1. A digital incident recording apparatus comprising:
means for continuously capturing actual visual scene that comes within the vicinity of said apparatus wherein said means for capturing visual scene is achieved by an image capturing unit,
means for buffering up a plurality of captured visual scene having finite number of storage elements over-written repeatedly using a first-in-first-out mechanism such that a finite storage can be used to hold a plurality of said visual scene continuously;
means for preserving said buffered scenes long enough to be useful after an incident has occurred;
means for triggering a preservation of said buffered scenes, wherein said triggering is a mechanism chosen from the group consisting of software mechanism, firmware mechanism, hardware mechanism and combinations thereof wherein said firmware or software mechanism comprises of programmable logic instructions that fire off a signal in responding to an external event, wherein said hardware mechanism comprises at least one sensor capable of sending out a signal upon detecting a physical event, wherein said physical event can be a physical impact, sudden change in momentum, shock wave, sudden change in sound wave amplitude, manual activation and combinations thereof, and means for providing overall operational control of said apparatus.

2. A digital incident recording apparatus as recited in claim 1 further comprises means for temporally storage using a volatile memory device.

3 A digital incident recording apparatus as recited in claim 1 further comprises means to draw power from a power source to provide continued operation, wherein said power source is chosen from the group consisting of a battery, a dc power supply, an ac power supply and a combination thereof.

4. A digital incident recording apparatus as recited in claim 1 wherein said means for preserving buffered scenes comprises of a persistent storage unit chosen from the group consisting of a persistent memory device, a volatile memory device having a continued power supply so as to retain its contains, a non-memory persistent storage media and a combination thereof.

5. A digital incident recording apparatus as recited in claim 4 wherein said means for buffering up said captured scenes is achieved by feeding said captured scenes into said persistent storage unit.

6. A digital incident recording apparatus as recited in claim 2 wherein said means for buffering up said captured scenes is achieved by feeding said captured scenes into said volatile memory unit.

7. A digital incident recording apparatus as recited in claim 1 further comprises:
additional said image capturing unit that captures scenes of side and back views to include activities of the operator when said apparatus is to be used inside a transportation system.

8. A digital incident recording apparatus as recited in claim 1 further comprises:
additional said image capturing unit that captures scenes of side and back views, wherein said additional unit has its own separate said means for buffering up said captured scenes and means for preserving said buffered scenes.

9. A digital accident recording apparatus as recited in claim 1 wherein said image capturing unit is used to capture scenes of forward view as well as backward view to include the activities of said operator.

10. A digital incident recording apparatus as recited in claim 1 further comprises
means for manually triggering said preservation of captured scenes, wherein said manually triggering can be an action selected from the group consisting of taking snap shots of visual scene, taking a sequence of continuous images of visual scene, and freezing the activity of said continuously capturing visual scene so as to prevent existing said scenes in said buffer of being replaced by new scenes in order to preserve existing said scenes.

11. A digital incident recording apparatus as recited in claim 1 further comprises a housing means to protect said persistent storage from being destroyed by environmental factor, wherein said factor includes temperature, impact, shaking, electrical shock and moisture.

12. A digital incident recording apparatus as recited in claim 1 further comprises
means for capturing sound wave in synchronization with the said captured visual scene;
means for buffering said captured sound wave using said first-in-first-out mechanism in the same manner as for said visual scene; and
means for preserving said buffered sound wave in the same manner as for said visual scene.

13. A digital incident recording apparatus as recited in claim 11 further comprises
an installation means which allows said apparatus to be taken out of an installation base and to be used as a recording apparatus outside of a transportation system, wherein said installation means is selected from the group consisting of attaching said apparatus onto a surface and inserting said apparatus into a housing unit large enough to hold said apparatus.

14. A digital incident recording apparatus as recited in claim 11 further comprises
an installation means which allows the said apparatus to be taken out of an installation base and to be used as a hand-held recording apparatus, wherein said installation means is selected from the group consisting of attaching said apparatus onto a surface and inserting said apparatus into a housing unit large enough to hold said apparatus.

15. A digital incident recording apparatus as recited in claim 1 wherein said means for overall operational control comprises of a control unit chosen from the group consisting of a micro-processor, a micro-controller, a DSP, a PAL, an EPLD, a FPGA and a programmable logic circuit.

16. A method for digitally recording incidents using a finite storage for capturing events that may occur at any time within a long time span comprises steps of:
continuously capturing the actual visual scene in real-time and converting said scene into digital form;
controlling the operation and timing of said capture process;
continuously buffering up a plurality of captured images using a first-in-first-out mechanism so that said buffered images can be preserved when needed; and
triggering a permanent preservation of a plurality of frames of said buffered images.

17. A method for digitally recording incidents as recited in claim 16 wherein said permanent preservation of a plurality of frames of visual scenes is achieved by prohibiting older said images from being erased and replaced by newer images such that said plurality of frames stored are composed of a number of images captured so many seconds before, during and after said triggering.

18. A method for digitally recording incident as recited in claim 16 further comprises the step of:
detecting an external event so as to generate said triggering, wherein said event is chosen from the group consisting of physical impact, sudden change of momentum, sudden change of sound amplitude, manual activation, unusual occurrence of objects in said captured images, distance between said objects, movement of said objects and a combination thereof.

19. A method for digitally recording incidents as recited in claim 16 further comprises the step of:
capturing rear and side view scenes to include the activities of the operator of a transportation system;
buffering said rear and side view scenes using said first-in-first-out mechanism; and
preserving said buffered images when said triggering occurs.

20. A method for digitally recording incidents as recited in claim 16 further comprises the step of:
capturing surrounding sound wave corresponding to said visual scene;
buffering said captured sound wave using said first-in-first-out mechanism in the same manner as for said visual scenes; and
preserving said buffered sound wave when said triggering occurs.
